(19) United States
(12) Patent Application Publication
(10) Pub. No.: US 2019/0086238 A1
(43) Pub. Date: Mar. 21, 2019

(54) LINEAR MOTION AND ROTATION DETECTOR, LINEAR MOTION AND ROTATION DETECTOR UNIT, AND LINEAR MOTION AND ROTATION DRIVE DEVICE

(71) Applicant: Nidec Corporation, Kyoto (JP)

(72) Inventors: Katsuya MORIYAMA, Nagano (JP); Fusayoshi ARUGA, Nagano (JP)

(21) Appl. No.: 16/195,891

(22) Filed: Nov. 20, 2018

Related U.S. Application Data
(63) Continuation of application No. PCT/JP2017/020568, filed on Jun. 2, 2017.

(30) Foreign Application Priority Data
Jun. 2, 2016 (JP) 2016-111091

(51) Int. Cl. G01D 5/16; F16C 41/00

(52) U.S. Cl. CPC G01D 5/16; F16C 41/007

(57) ABSTRACT

A linear motion and rotation detector that detects displacement of an output shaft includes a linear motion position detector including a linear motion scale that includes a linear motion position detection magnetization pattern on a circumferential wall surface facing in a radial direction, and a first magnetic detection element facing the linear motion position detection magnetization pattern from the radial direction and detecting a change in magnetic field, and a rotational position detector including a rotation scale that includes a rotational position detection magnetization pattern on a flat surface facing in an axial direction, and a rotational position detection magnetoresistance element facing the rotational position detection magnetization pattern from the axial direction and detecting a change in magnetic field. The linear motion scale moves in the axial direction together with the output shaft, and the rotation scale coaxially rotates with the output shaft at a predetermined position in the axial direction.

### CROSS REFERENCE TO RELATED APPLICATIONS

This application claims the benefit of priority to Japanese Patent Application No. 2016-111091 filed on Jun. 2, 2016 and is a Continuation Application of PCT Application No. PCT/JP2017/020568 filed on Jun. 2, 2017. The entire contents of each application are hereby incorporated herein by reference.

### BACKGROUND OF THE INVENTION

### 1. Field of the Invention

The present invention relates to a linear motion and rotation detector and a linear motion and rotation detector unit which detect a rotational position and a linear motion position of a moving body. The present invention also relates to a linear motion and rotation drive device including a linear motion and rotation detector detecting displacement of an output shaft.

### 2. Description of the Related Art

A linear motion and rotation drive device including a motor unit which linearly moves and rotates an output shaft, and a linear motion and rotation detector detecting displacement of the output shaft is described in Japanese Patent Application Laid-Open No. 2010-60478. The linear motion and rotation detector of Japanese Patent Application Laid-Open No. 2010-60478 includes a linear motion position detector which detects a linear motion position of the output shaft, and a rotational position detector which detects a rotational position of the output shaft.

The linear motion position detector includes a cylindrical linear motion scale fixed to the output shaft, and a linear motion displacement detector which detects a linear motion position of the output shaft by reading the linear motion scale. The linear motion scale has linear motion gradations provided at regular intervals in an axial direction in which the output shaft moves linearly.

The rotational position detector includes a cylindrical rotation scale coaxially fixed to the output shaft, and a rotational displacement detector which detects a rotational position of the output shaft by detecting a change in magnetic field of the rotation scale. The rotation scale is a permanent magnet in which two poles are magnetized around the axis. The rotational displacement detector includes two Hall elements disposed at different angular positions around the axis. Each of the two Hall elements faces a circumferential wall surface of the rotation scale from a radial direction perpendicular to the axis and detects a change in magnetic field generated by the rotation scale.

An output shaft of a linear motion and rotation drive device may be inclined with respect to a reference axis due to tolerances of components supporting the output shaft or the like. Here, in a case in which a rotational position detector is arranged such that a magnetic detection element such as a Hall element faces a rotation scale from a radial direction, when the rotation scale coaxial with the output shaft is inclined due to an inclination of the output shaft, there is a problem in that detection accuracy of a rotational position is likely to deteriorate.

That is, since a circumferential wall surface of the rotation scale is curved in a circular arc shape, a gap between the rotation scale and the magnetic detection element varies around the axis based on the curvature of the circumferential wall surface of the rotation scale. Therefore, even when the output shaft and the rotation scale are not inclined, the magnetic detection element causes detection of a magnetic strength due to the variation in the gap around the axis, and thus it is not easy to accurately detect a change in magnetic field generated by the rotation scale. Here, in addition, when the rotation scale is inclined, since the gap between the rotating rotation scale and the magnetic detection element varies, the magnetic strength also fluctuates. Therefore, it is more difficult to accurately detect the change in magnetic field generated by the rotation scale with the magnetic detection element. Therefore, the detection accuracy of the rotational position by a rotational position detector is more likely to deteriorate.

### SUMMARY OF THE INVENTION

In view of the above problems, preferred embodiments of the present invention provide linear motion and rotation detectors and linear motion and rotation detector units each capable of preventing deterioration of detection accuracy in detecting a rotational position of a moving body even when a rotation scale coaxial with the moving body is inclined due to an inclination of the moving body such as an output shaft. Also, preferred embodiments of the present invention provide linear motion and rotation drive devices that each detect displacement of an output shaft by such linear motion and rotation detectors.

A preferred embodiment of the present invention provides a linear motion and rotation detector detecting displacement of a moving body which linearly moves in an axial direction and rotates around an axis, and the linear motion and rotation detector includes a linear motion position detector including a linear motion scale that includes a circumferential wall surface surrounding the axis and facing in a radial direction and includes a linear motion position detection magnetization pattern in which an N-pole and an S-pole are magnetized on the circumferential wall surface and a first magnetic detection element facing the linear motion position detection magnetization pattern from the radial direction and detecting a change in magnetic field, and a rotational position detector including a rotation scale including a flat surface facing in the axial direction and a rotational position detection magnetization pattern in which an N-pole and an S-pole are magnetized on the flat surface and a second magnetic detection element facing the rotational position detection magnetization pattern from the axial direction and detecting a change in magnetic field, in which the linear motion scale moves in the axial direction together with the moving body, and the rotation scale rotates together with the moving body coaxially with the moving body at a predetermined position in the axial direction.

According to a preferred embodiment of the present invention, the rotation scale includes the rotational position detection magnetization pattern on the flat surface facing in the axial direction, and the second magnetic detection element faces the rotational position detection magnetization pattern (rotation scale) from the axial direction. Therefore, when the rotation scale is inclined, an amount of variation in which the gap between the rotating rotation scale and the second magnetic detection element varies is prevented as compared with a case in which a rotation scale includes a rotational position detection magnetization pattern on a circumferential wall surface and a second magnetic detection element faces the rotation scale from a radial direction. Further, when the second magnetic detection element faces the rotational position detection magnetization pattern (rotation scale) from the axial direction, it becomes easier to dispose the second magnetic detection element at a position close to the axis as compared with a case in which the second magnetic detection element faces the rotation scale from the radial direction. Here, if the second magnetic detection element is disposed at a position close to the axis, when the rotation scale is inclined, an amount of variation in which the gap between the rotating rotation scale and the second magnetic detection element varies is able to be prevented. Thus, even when the rotation scale is inclined, a fluctuation in magnetic strength due to the variation in the gap between the rotating rotation scale and the second magnetic detection element is able to be prevented. Therefore, even when the rotation scale coaxial with the moving body is inclined due to an inclination of the axis of the moving body, it is possible to prevent deterioration of detection accuracy in detecting a rotational position of the moving body.

In a preferred embodiment of the present invention, the rotational position detection magnetization pattern may include a grid shape in which S-poles and N-poles are alternately arranged around the axis and the S-poles and the N-poles are alternately magnetized in the radial direction, and the second magnetic detection element is able to detect a rotating magnetic field generated at a boundary portion between the S-poles and the N-poles of the rotational position detection magnetization pattern. In this way, it is possible to obtain a sine wave component indicating the rotational position based on an output from the second magnetic detection element.

In a preferred embodiment of the present invention, the rotational position detection magnetization pattern may be structured such that S-poles and N-poles are alternately arranged around the axis, and the second magnetic detection element is able to detect a strong and weak magnetic field of the rotational position detection magnetization pattern. Also in this way, it is possible to obtain a sine wave component indicating the rotational position based on the output from the second magnetic detection element.

In a preferred embodiment of the present invention, it is preferable that the rotation scale includes a magnetized region in which an S-pole or an N-pole is magnetized at a region different from the rotational position detection magnetization pattern of the flat surface in the radial direction, and that the rotational position detector includes a third magnetic detection element facing the flat surface from the axial direction and being able to detect a magnetic field of the magnetized region. In this way, it is possible to detect an origin position of the moving body (rotation scale) around the axis based on an output from the third magnetic detection element.

In a preferred embodiment of the present invention, the linear motion position detection magnetization pattern may include a grid shape in which S-poles and N-poles are alternately arranged in the axial direction and the S-poles and the N-poles are alternately magnetized around the axis, and the first magnetic detection element is able to detect a rotating magnetic field generated at a boundary portion between the S-poles and the N-poles of the linear motion position detection magnetization pattern. In this way, it is possible to obtain a sine wave component indicating the linear motion position based on an output from the first magnetic detection element.

In a preferred embodiment of the present invention, the linear motion position detection magnetization pattern may be structured such that S-poles and N-poles are alternately arranged in the axial direction, and the first magnetic detection element is able to detect a strong and weak magnetic field of the linear motion position detection magnetization pattern. Also in this way, it is possible to obtain a sine wave component indicating the linear motion position based on the output from the first magnetic detection element.

Further, a linear motion and rotation detector unit according to a preferred embodiment of the present invention includes the linear motion and rotation detector described above, and a ball spline bearing fixed to a moving body, in which the ball spline bearing supports the moving body to be movable in an axial direction and rotates together with the moving body, and a rotation scale is attached to the moving body via the ball spline bearing.

According to a preferred embodiment of the present invention, the rotation scale of the linear motion and rotation detector includes a rotational position detection magnetization pattern on a flat surface facing in the axial direction, and a second magnetic detection element faces the rotational position detection magnetization pattern (rotation scale) from the axial direction. Therefore, even when the rotation scale coaxial with the moving body is inclined due to an inclination of the moving body with respect to a reference axis caused by tolerances of components supporting the moving body or the like, deterioration of detection accuracy in detecting a rotational position of the moving body is able to be prevented. Also, the rotation scale is attached to the moving body via the ball spline bearing which supports the moving body to be movable in the axial direction. Therefore, the rotation scale rotates together with the moving body coaxially with the moving body at a predetermined position in the axial direction, and does not move in the axial direction. Therefore, when the moving body moves in the axial direction, the second magnetic detection element facing the rotation scale from the axial direction does not collide with the rotation scale.

Further, a linear motion and rotation drive device according to a preferred embodiment of the present invention includes an output shaft, a linear motion drive unit that moves the output shaft in an axial direction, a rotation drive unit including a rotor rotating around an axis, a ball spline bearing coaxially fixed to the output shaft, supporting the output shaft to be movable in the axial direction, and integrally rotating with the output shaft, and a linear motion and rotation detector that detects displacement of the output shaft, in which the rotor is fixed to the ball spline bearing, the linear motion and rotation detector includes a linear motion position detector including a linear motion scale that includes a circumferential wall surface surrounding the axis and facing in a radial direction and including a linear motion position detection magnetization pattern in which an N-pole and an S-pole are magnetized on the circumferential wall surface and a first magnetic detection element facing the linear motion position detection magnetization pattern from the radial direction and detecting a change in magnetic field, and a rotational position detector including a rotation scale including a flat surface facing in the axial direction and including a rotational position detection magnetization pattern in which an N-pole and an S-pole are magnetized on the flat surface and a second magnetic detection element facing the rotational position detection magnetization pattern from the axial direction and detecting a change in magnetic field, the linear motion scale is fixed to the output shaft and moves in the axial direction together with the output shaft, and the rotation scale is fixed to the rotor and rotates together with the output shaft coaxially with the output shaft at a predetermined position in the axial direction.

According to a preferred embodiment of the present invention, the rotation scale of the linear motion and rotation detector includes the rotational position detection magnetization pattern on a flat surface facing in the axial direction, and the second magnetic detection element faces the rotational position detection magnetization pattern (rotation scale) from the axial direction. Therefore, even when the rotation scale coaxial with the output shaft is inclined due to an inclination of the output shaft with respect to a reference axis caused by tolerances of components supporting the output shaft or the like, deterioration of detection accuracy in detecting a rotational position of the output shaft is able to be prevented. Also, the rotation scale is fixed to the ball spline bearing which supports the output shaft to be movable in the axial direction. Therefore, the rotation scale rotates coaxially with the output shaft at a predetermined position in the axial direction, and does not move in the axial direction. Therefore, when the output shaft moves in the axial direction, the second magnetic detection element facing the rotation scale from the axial direction does not collide with the rotation scale.

According to the linear motion and rotation detectors and the linear motion and rotation detector units of preferred embodiments of the present invention, even when the rotation scale coaxial with the moving body is inclined due to an inclination of the moving body such as an output shaft, deterioration of detection accuracy in detecting a rotational position of the moving body is able to be prevented. Further, according to the linear motion and rotation drive devices of preferred embodiments of the present invention, even when the rotation scale coaxial with the output shaft is inclined due to an inclination of the output shaft with respect to a reference axis, deterioration of detection accuracy in detecting a rotational position of the output shaft is able to be prevented.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an external perspective view of a linear motion and rotation drive device according to a preferred embodiment of the present invention.

FIG. 2 is a cross-sectional view of the linear motion and rotation drive device of FIG. 1 taken along a plane including an axis.

FIG. 3 is a perspective view of an output shaft and a ball spline bearing.

FIG. 4 is an enlarged partial cross-sectional view illustrating a rotation drive unit.

FIG. 5 is an enlarged partial cross-sectional view illustrating a linear motion drive unit.

FIG. 6 is an explanatory view of a linear motion and rotational position detector.

FIGS. 7A, 7B and 7C are an explanatory view of a rotational position detection magnetic sensor of a rotational position detector.

FIGS. 8A and 8B are an explanatory view of a circuit including a rotational position detection magnetoresistance element.

FIGS. 9A, 9B and 9C are an explanatory view of a linear motion position detection magnetic sensor of a linear motion position detector.

FIG. 10 is an explanatory view of a linear motion and rotation detector of a modified example.

### DETAILED DESCRIPTION OF THE PREFERRED EMBODIMENTS

Hereinafter, a linear motion and rotation drive device of an embodiment of the present invention will be described with reference to the drawings.

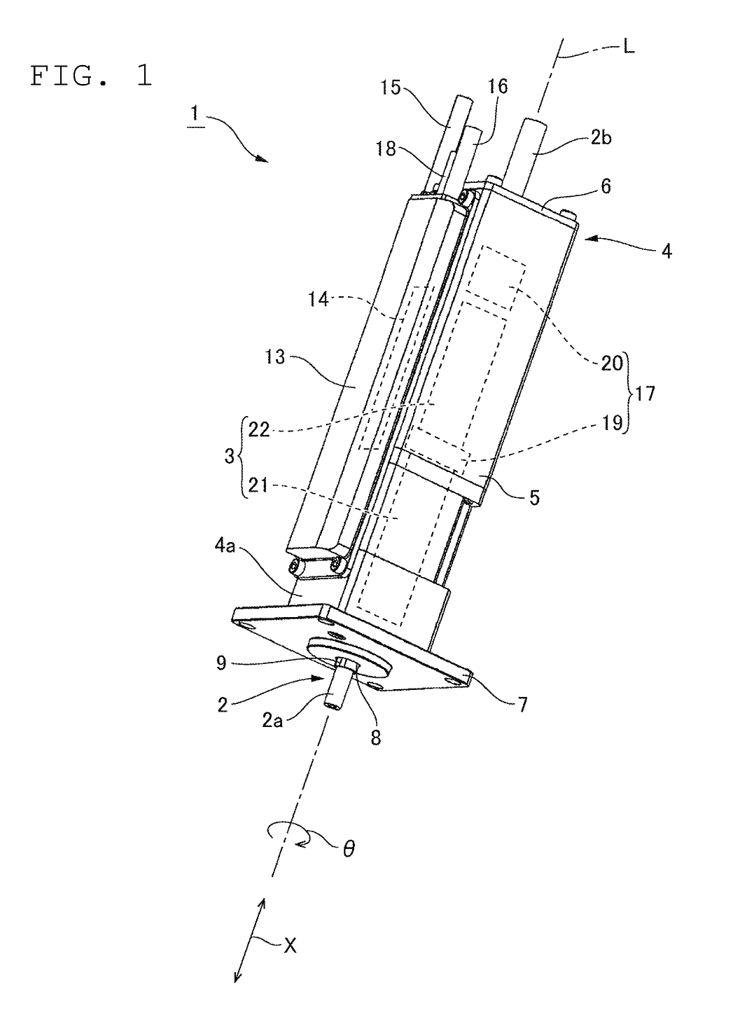

FIG. 1 is an external perspective view of a linear motion and rotation drive device including a linear motion and rotation detector of the present invention. As illustrated in FIG. 1, a linear motion and rotation drive device 1 of the present example includes an output shaft (moving body) 2, an output shaft drive mechanism 3 which drives the output shaft 2, and a case 4 which accommodates the output shaft drive mechanism 3. The case 4 includes a rectangular cylindrical case body 5 extending in an axial direction X along an axis L of the output shaft 2. The case body 5 has a rectangular shape when viewed from the axial direction X. A flange 7 having a rectangular plate shape is fixed to one end of the case body 5. The flange 7 extends in a direction perpendicular to the axis L at the one end of the case body 5. Also, a rectangular plate 6 is fixed to the other end portion of the case body 5.

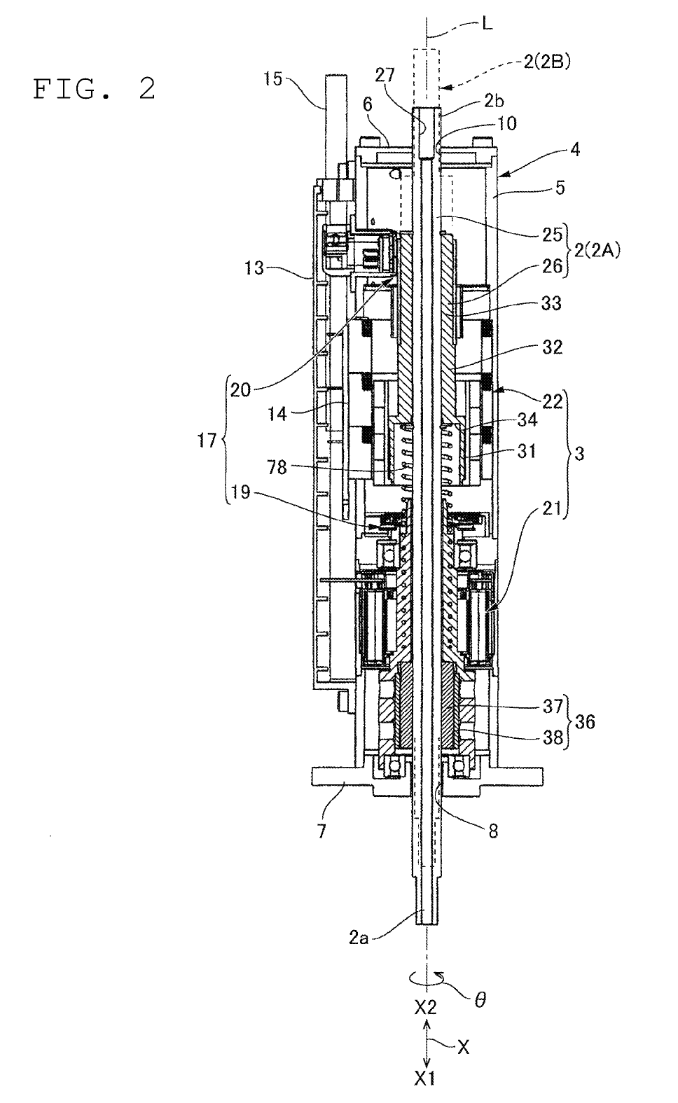

At a center of the flange 7, an output-side opening 8 is provided. An end portion 2a of the output shaft 2 on an output side protrudes from the output-side opening 8 to the outside of the case 4. A spline groove 9 is provided on the output shaft 2. An opposite output-side opening 10 (see FIG. 2) is provided at a center of the rectangular plate 6. An end portion 2b of the output shaft 2 on an opposite output side protrudes from the opposite output-side opening 10 to the outside of the case 4. The opposite output-side opening 10 is a bearing which rotatably supports the output shaft 2 in a direction θ around the axis and supports the output shaft 2 to be linearly movable in the axial direction X on an inner circumferential surface thereof.

A cover 13 is attached to one side surface 4a among four side surfaces of the case body 5 in the direction θ around the axis. The cover 13 extends long in the axial direction X. A circuit board 14 for controlling power supply to the output shaft drive mechanism 3 is accommodated in a space on an inner side of the cover 13 partitioned between the cover 13 and the case body 5 (see FIG. 2). Cables 15 and 16 for supplying power to the circuit board 14 are connected to the circuit board 14. Also, a cable 18 for taking a detection signal out of a linear motion and rotation detector 17 which detects displacement of the output shaft 2 to the outside is connected from the cover 13. The linear motion and rotation detector 17 includes a rotational position detector 19 for detecting a rotational position of the output shaft 2 in the direction θ around the axis, and a linear motion position detector 20 for detecting a linear motion position of the output shaft 2 in the axial direction X.

FIG. 2 is a longitudinal sectional view of the linear motion and rotation drive device 1 of FIG. 1 taken along a plane including the axis L. In FIG. 2, the linear motion and rotation drive device 1 assumes a reference posture. The reference posture is a posture in which the end portion 2a on the output side of the output shaft 2 is directed downward and the axis L of the output shaft 2 is in a vertical direction. In the following description, up and down in the reference posture illustrated in FIG. 2 will be described as a vertical direction X (axial direction) of the linear motion and rotation drive device 1. Also, in the following description, when the linear motion and rotation drive device 1 assumes the reference posture, a lower side in the vertical direction is defined as X1 and an upper side thereof is defined as X2.

As illustrated in FIG. 2, the output shaft drive mechanism 3 includes a rotation drive unit 21 for rotating the output shaft 2 in the direction θ around the axis, and a linear motion drive unit 22 for moving the output shaft 2 in the vertical direction X. The rotation drive unit 21 is positioned on the lower side X1 of the linear motion drive unit 22 in the vertical direction X. The rotation drive unit 21 is configured to be coaxial with the linear motion drive unit 22. The rotational position detector 19 is positioned between the rotation drive unit 21 and the linear motion drive unit 22 in the vertical direction X. The linear motion position detector 20 is positioned on an upper side of the linear motion drive unit 22.

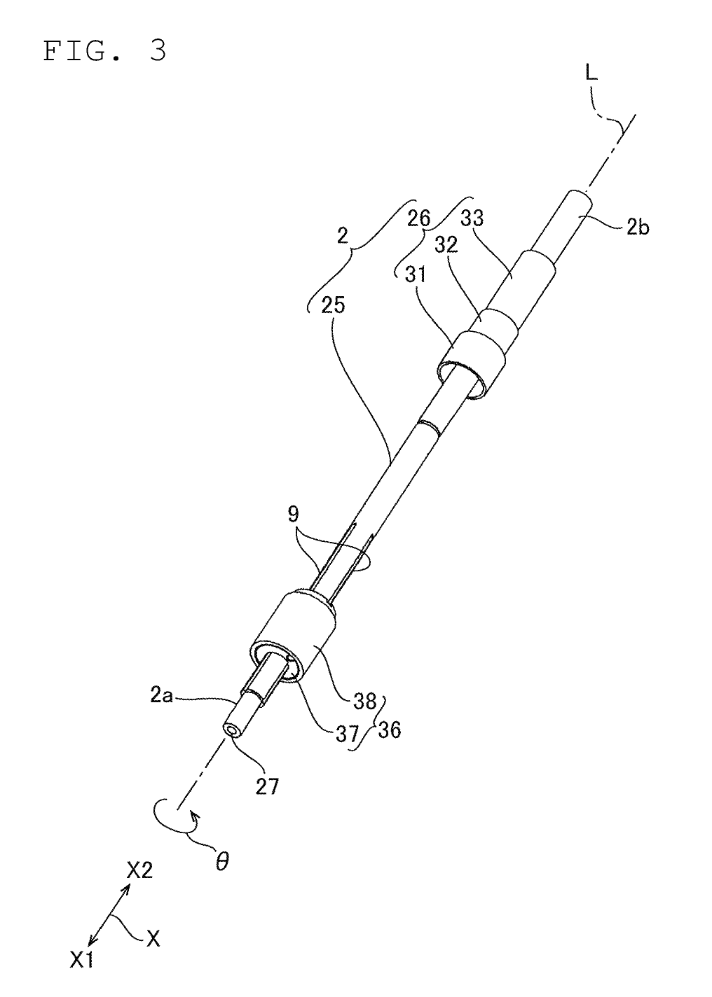

FIG. 3 is a perspective view of the output shaft 2 and a ball spline bearing coaxially attached to the output shaft 2. As illustrated in FIGS. 2 and 3, the output shaft 2 includes an output shaft body 25 penetrating and extending through the rotation drive unit 21 and the linear motion drive unit 22, and a cylindrical fixing member 26 coaxially fixed to an upper side portion of the output shaft body 25. As illustrated in FIG. 2, a lower end portion of the output shaft body 25 (end portion 2a on the output-side) protrudes toward the lower side X1 from the output-side opening 8 of the case 4, and an upper end portion of the output shaft body 25 (end portion 2b on the opposite output-side) protrudes toward the upper side X2 from the case 4 via the opposite output-side opening 10. A through hole 27 penetrating in the vertical direction X is provided in the output shaft body 25.

As illustrated in FIG. 3, the fixing member 26 includes a large-diameter cylindrical portion 31, an intermediate-diameter cylindrical portion 32 coaxial with the large-diameter cylindrical portion 31 and having a smaller outer diameter dimension than the large-diameter cylindrical portion 31, and a small-diameter cylindrical portion 33 having a smaller outer diameter dimension than the intermediate-diameter cylindrical portion 32 in this order from the lower side X1 toward the upper side X2. A center hole of the large-diameter cylindrical portion 31 is larger than a center hole of each of the intermediate-diameter cylindrical portion 32 and the small-diameter cylindrical portion 33. As illustrated in FIG. 2, an annular end surface portion 34 is provided between the center hole of the large-diameter cylindrical portion 31 and the center hole of the intermediate-diameter cylindrical portion 32. The annular end surface portion 34 is an annular end surface facing the lower side X1. In the fixing member 26, the output shaft body 25 is press-fitted into the center hole of the intermediate-diameter cylindrical portion 32 and the small-diameter cylindrical portion 33, and thereby the fixing member 26 is fixed to the output shaft body 25.

A ball spline bearing 36 which is coaxial with the output shaft 2 is attached to a lower portion of the output shaft 2. Balls (not illustrated) constituting the ball spline bearing 36 are rollably inserted into the spline groove 9 provided on the lower portion of the output shaft 2. The ball spline bearing 36 coaxially supports the output shaft 2 to be movable in the vertical direction X and rotates integrally with the output shaft 2. The ball spline bearing 36 includes a cylindrical bearing body 37 and a cylindrical sleeve 38 integrated with the bearing body 37 by shrink fitting. A contour shape of the ball spline bearing 36 is circular when viewed from the vertical direction X.

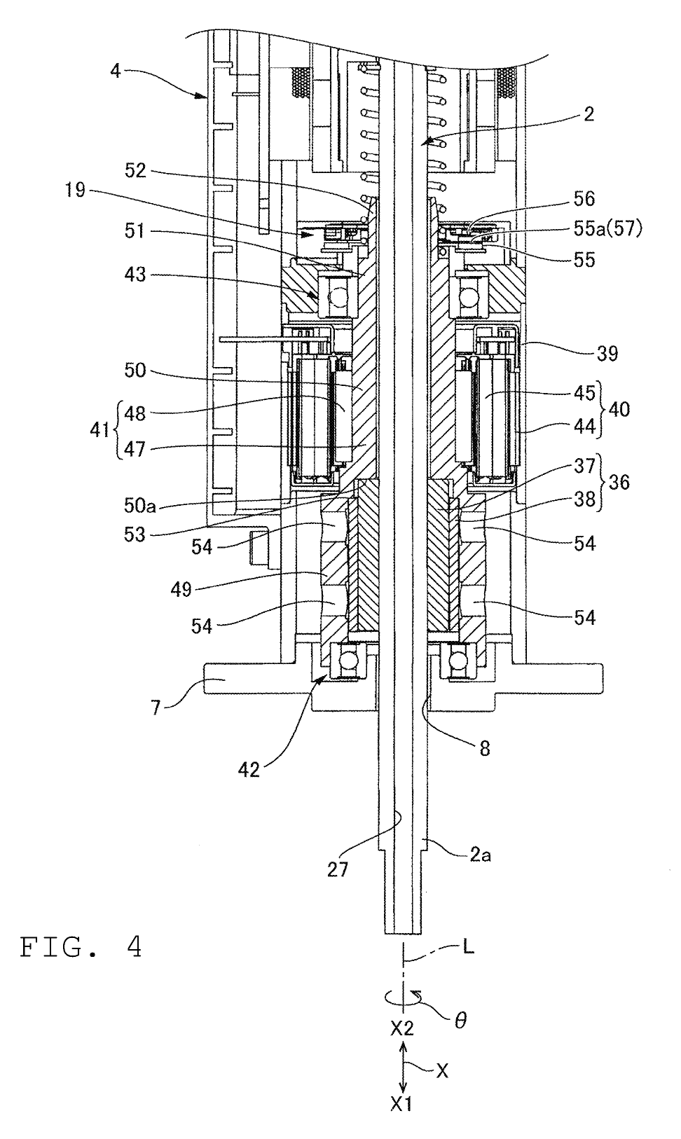

FIG. 4 is an enlarged partial cross-sectional view illustrating the rotation drive unit 21 and the rotational position detector 19. The rotation drive unit 21 is a rotary motor. As illustrated in FIG. 4, the rotation drive unit 21 includes a motor case 39 having a rectangular frame shape, an annular stator 40 fixed inside the motor case 39, an annular rotor 41 disposed on an inner circumferential side of the stator 40, a first bearing 42 which supports a lower end portion of the rotor 41, and a second bearing 43 which supports an upper portion of the rotor 41. The first bearing 42 and the second bearing 43 are ball bearings.

The motor case 39 constitutes a portion of the case body 5. The stator 40 includes a stator core 44 having a plurality of salient poles (not illustrated) protruding toward the inside in a radial direction and a plurality of rotation drive coils 45 wound around the salient poles of the stator core 44.

The rotor 41 includes a cylindrical member 47 and a permanent magnet 48. The cylindrical member 47 includes a large-diameter cylindrical portion 49, an intermediate-diameter cylindrical portion 50 which is coaxial with the large-diameter cylindrical portion 49 and has an outer diameter dimension smaller than that of the large-diameter cylindrical portion 49, a small-diameter cylindrical portion 51 which is coaxial with the intermediate-diameter cylindrical portion 50 and has an outer diameter dimension smaller than that of the intermediate-diameter cylindrical portion 50, and a rotation scale fixing cylindrical portion 52 which is coaxial with the small-diameter cylindrical portion 51 and has an outer diameter dimension smaller than that of the small-diameter cylindrical portion 51. A center hole of the large-diameter cylindrical portion 49 is larger than a center hole of the intermediate-diameter cylindrical portion 50. Accordingly, as illustrated in FIG. 4, an annular end surface portion 50a is provided between the center hole of the large-diameter cylindrical portion 49 and the center hole of the intermediate-diameter cylindrical portion 50. The annular end surface portion 50a is an annular end surface facing the lower side X1. Also, a step portion 53 having an annular surface facing the lower side X1 is provided on an inner circumferential surface of the large-diameter cylindrical portion 49. Further, a plurality of adhesive injection holes 54 penetrating in a radial direction are provided in the large-diameter cylindrical portion 49. In the present example, four pairs of adhesive injection holes 54 in which each pair of two adhesive injection holes 54 are arranged in the vertical direction X are provided at equiangular intervals in the direction θ around the axis.

The output shaft 2 passes through a center hole of the cylindrical member 47. The ball spline bearing 36 attached to the output shaft 2 is positioned on an inner circumferential side of the large-diameter cylindrical portion 49. The sleeve 38 of the ball spline bearing 36 abuts against the step portion 53 of the inner circumferential surface of the large-diameter cylindrical portion 49 from the lower side X1 in the vertical direction X.

The ball spline bearing 36 is fixed to the large-diameter cylindrical portion 49 by an adhesive injected from an outer circumferential side to an inner circumferential side of the rotor 41 via the adhesive injection holes 54. Thereby, the output shaft 2 supported by the ball spline bearing 36 is coaxial with the rotor 41. Also, the output shaft 2 rotates integrally with the rotor 41 by the ball spline bearing 36 being fixed to the rotor 41. In other words, rotation of the rotor 41 can be transmitted to the output shaft 2 via the ball spline bearing 36.

The permanent magnet 48 has a cylindrical shape and is fixed to an outer circumferential surface of the intermediate-diameter cylindrical portion 50. The permanent magnet 48 has a plurality of N-poles and S-poles alternately magnetized in the direction θ around the axis. In the present example, a cylindrical yoke (not illustrated) is mounted on the intermediate-diameter cylindrical portion 50, and the permanent magnet 48 is fixed to the intermediate-diameter cylindrical portion 50 with the yoke interposed therebetween. The permanent magnet 48 faces salient poles of the stator core 44 around which the rotation drive coils 45 are wound with a small clearance therebetween in the radial direction.

The rotor 41 is rotated in the direction θ around the axis when power is supplied to the rotation drive coils 45. The rotation of the rotor 41 is transmitted to the output shaft 2 via the ball spline bearing 36. Thus, the output shaft 2 rotates integrally with the rotor 41.

The rotational position detector 19 includes a rotation scale 55 and a rotational position detection magnetic sensor 56. The rotation scale 55 has an annular shape and is coaxially fixed to the cylindrical member 47 in a state in which the rotation scale fixing cylindrical portion 52 is inserted into a center hole thereof. Thereby, the rotation scale 55 is attached to the output shaft 2 via the cylindrical member 47 and the ball spline bearing 36. Therefore, the rotation scale 55 is coaxial with the rotor 41 and rotates integrally with the rotor 41. Also, since the rotor 41 is coaxially fixed to the output shaft 2, the rotation scale 55 is coaxial with the output shaft 2 and rotates integrally with the output shaft 2. An upper surface 55a of the rotation scale 55 is a flat surface and extends in a direction perpendicular to the axis L. The rotation scale 55 includes a rotational position detection magnetization pattern 57 on the upper surface.

The rotational position detection magnetic sensor 56 is disposed at a position facing the rotational position detection magnetization pattern 57 in the vertical direction X. The rotational position detection magnetic sensor 56 is fixed to the case 4. A rotational position of the output shaft 2 is acquired based on a detection signal output from the rotational position detection magnetic sensor 56. Details of the rotational position detector 19 will be described below.

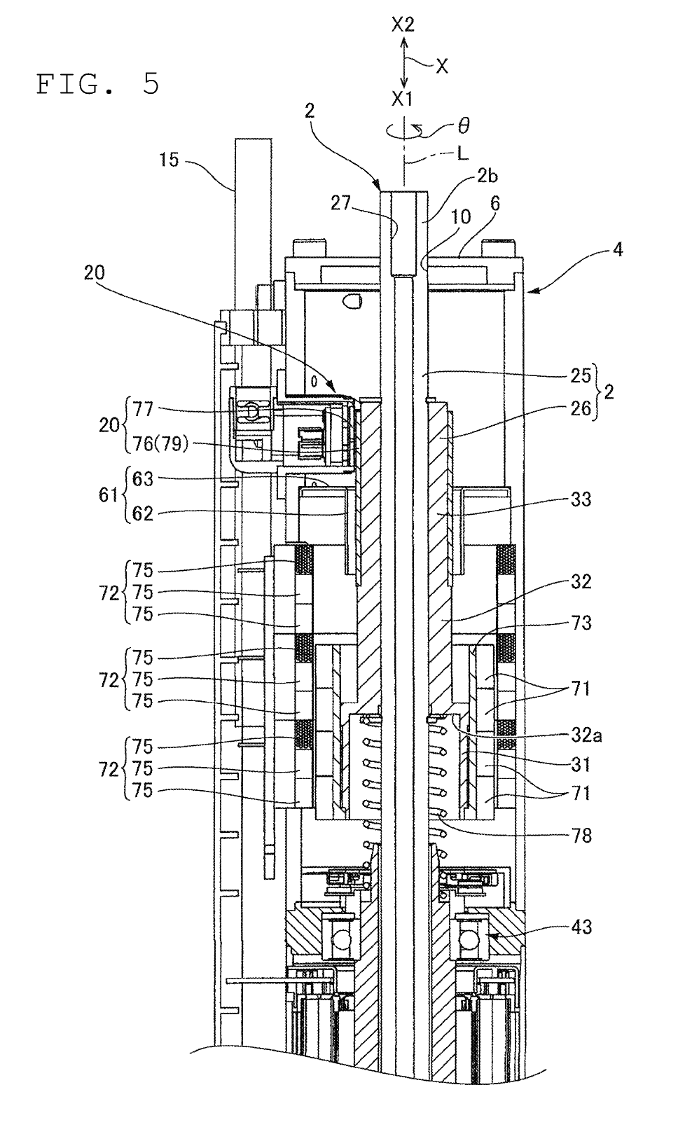

FIG. 5 is an enlarged partial cross-sectional view illustrating the linear motion drive unit 22 and the linear motion position detector 20. The linear motion drive unit 22 is a linear motor. The linear motion drive unit 22 includes a plurality of permanent magnets 71 fixed to the output shaft 2 and a plurality of linear motion drive coil units 72 arranged in the vertical direction X while surrounding the output shaft 2 from an outer circumference side. The plurality of permanent magnets 71 are fixed to an outer circumferential surface of a cylindrical yoke 73 mounted on an outer circumferential surface of the large-diameter cylindrical portion 31 of the fixing member 26. The yoke 73 has a constant diameter dimension. Further, a length dimension of the yoke 73 in the vertical direction X is longer than a length dimension of the large-diameter cylindrical portion 31 in the axial direction, and a gap formed between an upper end side portion of the yoke 73 on an outer circumferential side of the intermediate-diameter cylindrical portion 32 of the fixing member 26 and an outer circumferential surface of the intermediate-diameter cylindrical portion 32 extends in the vertical direction X.

Each of the permanent magnets 71 is annular, and an N-pole and an S-pole are magnetized in the vertical direction X. The plurality of permanent magnets 71 are arranged such that two adjacent permanent magnets 71 face the same pole each other in the vertical direction X. In the present example, four permanent magnets 71 are fixed to the output shaft 2 with the yoke 73 interposed therebetween.

The linear motion drive coil units 72 are fixed to an inner wall surface of the case body 5. Each of the linear motion drive coil units 72 is formed into a cylindrical shape by integrally solidifying three linear motion drive coils 75 coaxially arranged in the vertical direction X with a resin. Therefore, the linear motion drive unit 22 includes nine linear motion drive coils 75. A length dimension of each linear motion drive coil unit 72 in the vertical direction X is about twice a length dimension of each permanent magnet 71 in the vertical direction X.

Here, the linear motion drive unit 22 is a three-phase linear motor, and the three linear motion drive coils 75 constituting each linear drive coil unit 72 function as a U-phase drive coil, a V-phase drive coil, and a W-phase drive coil respectively when the linear motor is driven.

A coil spring 78 as an elastic member is disposed between the second bearing 43 of the rotation drive unit 21 and the fixing member 26 of the output shaft 2. The coil spring 78 surrounds the output shaft body 25 from an outer circumferential side with the output shaft body 25 penetrating therethrough. An end on the lower side X1 of the coil spring 78 (an end on the rotation drive unit 21 side) is placed on the rotor 41. Further, an upper end portion of the coil spring 78 is inserted into an inner circumferential side of the large-diameter cylindrical portion 31 of the fixing member 26, and an end thereof on the upper side X2 abuts against an annular end surface 32a of the fixing member 26. When the linear motion and rotation drive device 1 assumes the reference posture in a state in which power supply to the linear motion and rotation drive device 1 (power supply to the linear motion drive unit 22) is not performed, the coil spring 78 supports the output shaft 2 at a predetermined position in the vertical direction X.

The linear motion drive unit 22 moves the output shaft 2 in the vertical direction X by moving the linear motion drive coils 75 to which power is supplied in the vertical direction X. Also, the linear motion drive unit 22 maintains the output shaft 2 that has moved in the vertical direction X at the linearly moved position by maintaining the state of supplying power to the linear motion drive coils 75.

The linear motion position detector 20 includes a linear motion scale 76 and a linear motion position detection magnetic sensor 77. The linear motion scale 76 has a cylindrical shape and is coaxially fixed to the output shaft 2 in a state in which the small-diameter cylindrical portion 33 is inserted into a center hole thereof. As a result, the linear motion scale 76 linearly moves integrally with the output shaft 2. In the rotation scale 55, a linear motion position detection magnetization pattern 79 is provided on an annular circumferential wall surface 76a facing outward in the radial direction perpendicular to the vertical direction X.

The linear motion position detection magnetic sensor 77 is disposed at a position facing the linear motion position detection magnetization pattern 79 in the radial direction. The linear motion position detection magnetic sensor 77 is fixed to the case 4. A linear motion position of the output shaft 2 is acquired based on a detection signal output from the linear motion position detection magnetic sensor 77.

Here, a shield member 61 is disposed between the linear motion position detection magnetic sensor 77 and the linear motion drive unit 22. The shield member 61 includes a cylindrical portion positioned between the intermediate-diameter cylindrical portion 32 of the output shaft 2 and the yoke 73 in the radial direction, and an annular plate portion 63 extending from an upper end edge of the cylindrical portion 62 to the outer circumferential side and reaching the inner wall surface of the case body 5. When the output shaft 2 moves to the upper side X2 (opposite output-side), the cylindrical portion 62 enters between the intermediate-diameter cylindrical portion 32 of the output shaft 2 and the yoke 73. The shield member 61 prevents or prevents a magnetic field of the permanent magnets 71 of the linear motion drive unit 22 from affecting the linear motion position detector 20.

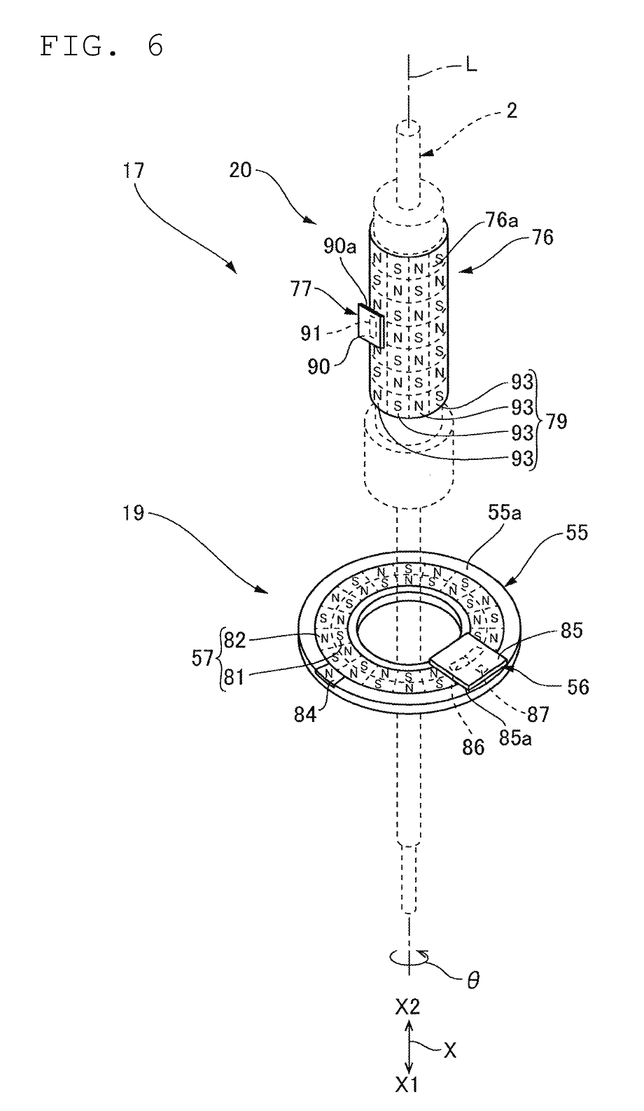

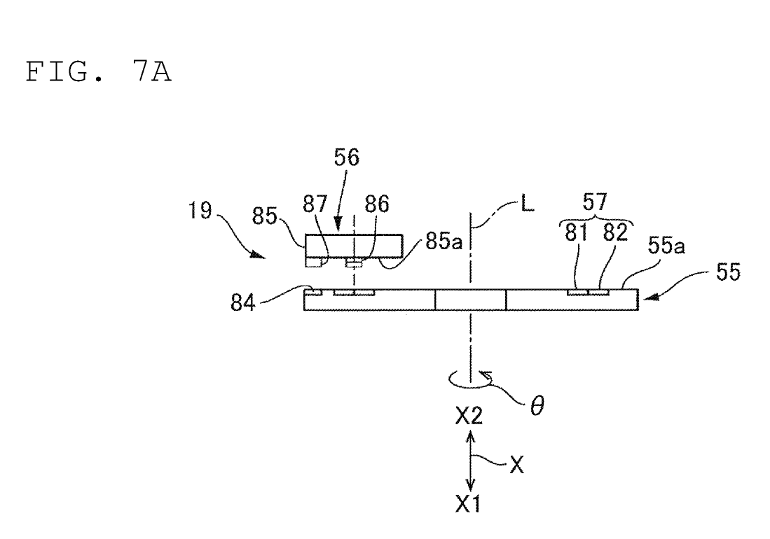

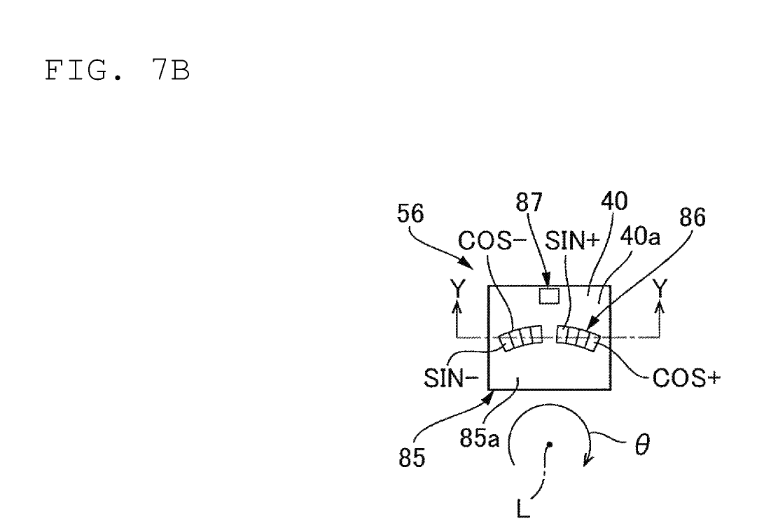

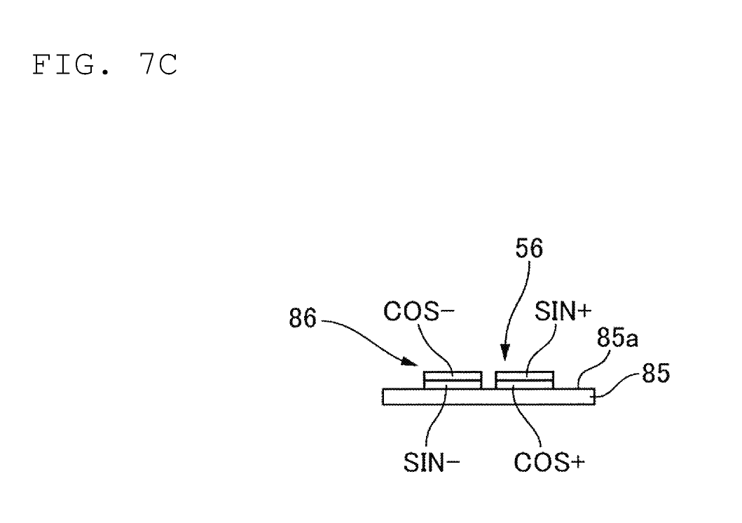

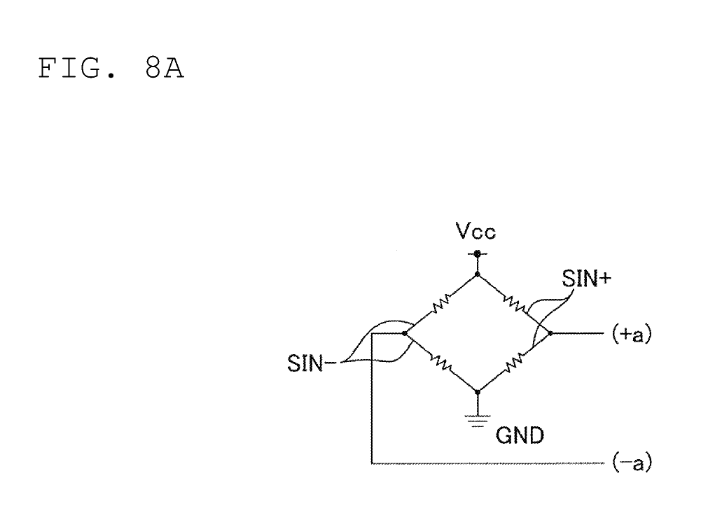

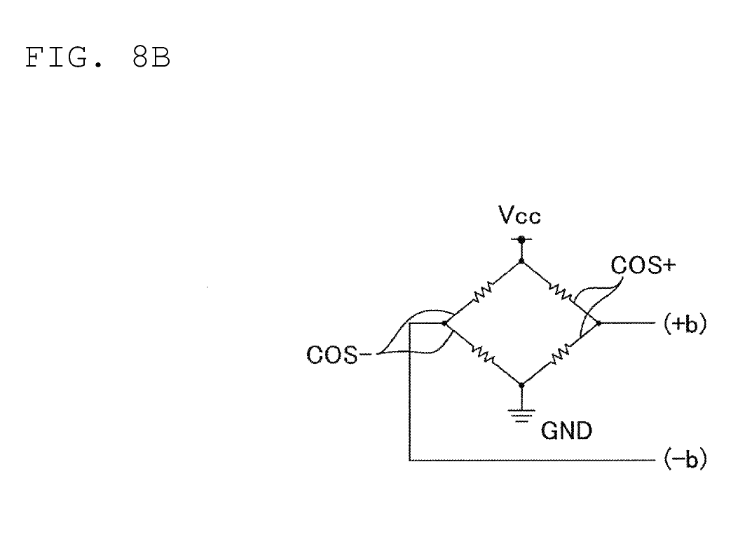

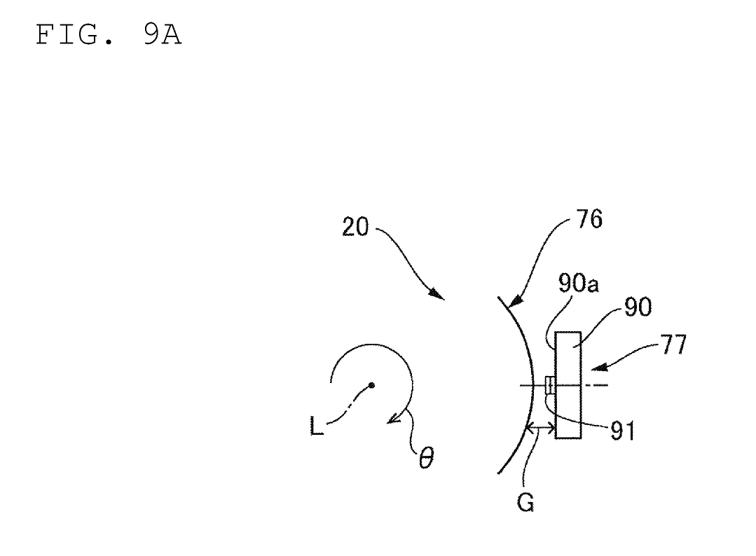

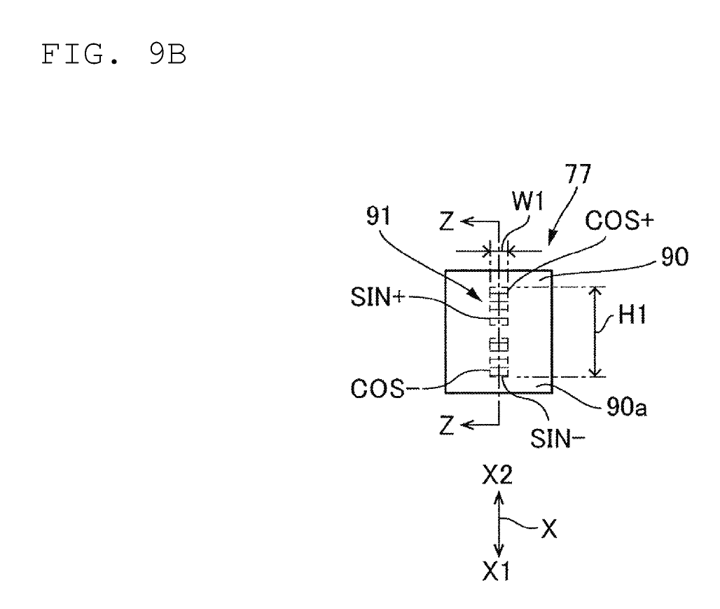

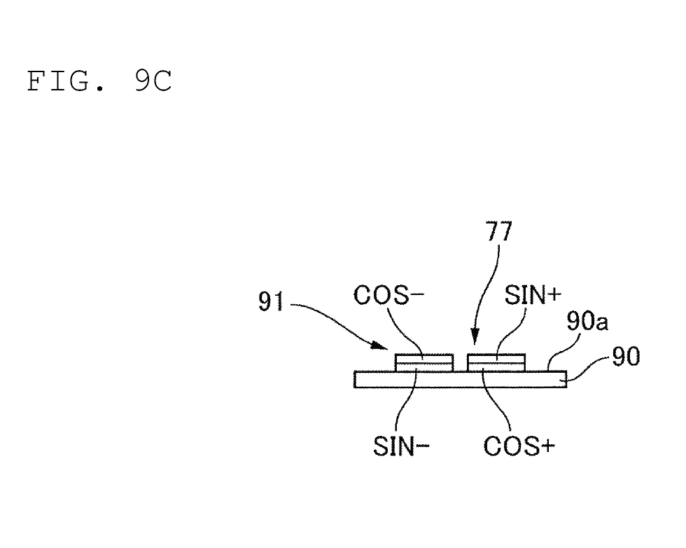

Next, the linear motion and rotation detector 17 will be described in detail with reference to FIGS. 6 to 9. FIG. 6 is an explanatory view of the linear motion and rotation detector 17. In FIG. 6, main portions of the linear motion and rotation detector 17 and the output shaft 2 are taken out from the linear motion and rotation drive device 1 and illustrated. FIGS. 7A to 7C are an explanatory view of the rotational position detection magnetic sensor 56. FIG. 7A is a cross-sectional view of the rotation scale 55 and the rotational position detection magnetic sensor 56 taken along a plane including the axis L, FIG. 7B is a plan view of the rotational position detection magnetic sensor 56 when viewed from the lower side X1, and FIG. 7C is a cross-sectional view taken along line Y-Y in FIG. 7B. In FIG. 7C, a surface of a sensor substrate on a side on which a rotational position detection magnetoresistance element is formed faces upward. FIGS. 8A and 8B are a circuit diagram configured by each of magnetic resistance patterns SIN+, SIN−, COS+, and COS− of a rotational position detection magnetoresistance element 86. FIGS. 9A to 9C is an explanatory view of the linear motion position detection magnetic sensor 77. FIG. 9A is a cross-sectional view of the linear motion scale 76 and the linear motion position detection magnetic sensor 77 taken along a plane perpendicular to the axis L, FIG. 9B is a side view of the linear motion position detection magnetic sensor 77 when viewed from the axis L side, and FIG. 9C is a cross-sectional view taken along line Z-Z of FIG. 9B. In FIG. 9C, a surface of the sensor substrate on a side on which a linear motion position detection magnetoresistance element is formed faces upward.

As illustrated in FIG. 6, the rotation scale 55 includes a rotational position detection magnetization pattern 57 on an upper surface 55a thereof. The rotational position detection magnetization pattern 57 has a grid shape in which S-poles and N-poles are alternately magnetized in the direction θ around the axis and the S-poles and the N-poles are alternately arranged in the radial direction. In other words, the rotational position detection magnetization pattern 57 includes an annular first magnetic track 81 having S-poles and N-poles alternately magnetized in the direction θ around the axis, and an annular second magnetic track 82 having S-poles and N-poles alternately magnetized in the direction θ around the axis on an outer circumferential side of the first magnetic track 81. The first magnetic track 81 and the second magnetic track 82 are provided without a clearance therebetween in the radial direction. A magnetization pitch of each pole in the first magnetic track 81 is the same as a magnetization pitch of each pole in the second magnetic track 82. Poles of magnetized regions adjacent to each other in the radial direction in the first magnetic track 81 and the second magnetic track 82 are different from each other.

Also, the rotation scale 55 includes an origin position detection magnetized region 84 on an outer circumferential side of the second magnetic track 82 on the upper surface 55a. The origin position detection magnetized region 84 is provided at one position in the direction θ around the axis. A width of the origin position detection magnetized region 84 in the direction θ around the axis is shorter than a pitch of magnetized regions of each pole in the first magnetic track 81 and the second magnetic track 82. Also, a center of the origin position detection magnetized region 84 in the direction θ around the axis is positioned in the origin position detection magnetized region 84 on an outer circumferential side of a boundary portion at which an S-pole and an N-pole are adjacent in the second magnetic track 82. In the present example, the origin position detection magnetized region 84 is magnetized to an N-pole. Also, the origin position detection magnetized region 84 may be magnetized to an S-pole.

As illustrated in FIG. 7A, the rotational position detection magnetic sensor 56 includes a sensor substrate 85 facing the rotation scale 55 from the upper side X2. The sensor substrate includes a rotational position detection magnetoresistance element 86 (second magnetic detection element) and an origin position detection magnetoresistance element (third magnetic detection element) 87 on a substrate surface 85a facing the rotation scale 55. The sensor substrate 85 is formed of glass or silicon. The rotational position detection magnetoresistance element 86 and the origin position detection magnetoresistance element 87 are formed by stacking a magnetic material film such as a ferromagnetic material NiFe on the substrate surface 85a by a semiconductor process.

The rotational position detection magnetoresistance element 86 faces the rotational position detection magnetization pattern 57 with a magnetism sensing direction thereof facing in the direction θ around the axis. As illustrated in FIG. 7B, a formation region of the rotational position detection magnetoresistance element 86 is a circular arc shape around the axis L as a whole. A curvature of the formation region of the rotational position detection magnetoresistance element 86 on the sensor substrate 85 is the same as a curvature of a boundary portion between the first magnetic track 81 and the second magnetic track 82 (a portion in which an N-pole and an S-pole are adjacent to each other).

Here, the rotational position detection magnetoresistance element 86 detects a rotating magnetic field generated at the boundary portion between the first magnetic track 81 and the second magnetic track 82 (a portion in which an N-pole and an S-pole are adjacent to each other). Also, the rotational position detection magnetoresistance element 86 detects the rotating magnetic field using a saturation sensitivity region of the magnetoresistance element. That is, the rotational position detection magnetoresistance element 86 causes a current to flow in the magnetic resistance pattern to be described below and applies a magnetic field strength at which a resistance value is saturated thereto, and thereby detects the rotating magnetic field whose direction in an in-plane direction changes at the boundary portion. Here, when the rotating magnetic field generated by the rotational position detection magnetization pattern 57 is detected by the rotational position detection magnetoresistance element 86, since a sine wave component can be obtained from the rotational position detection magnetoresistance element 86 even when the rotation scale 55 and the rotational position detection magnetoresistance element 86 are disposed close to each other, the rotational position detector 19 can be configured to be compact in the vertical direction X.

As illustrated in FIG. 7B, the rotational position detection magnetoresistance element 86 includes a first magnetic resistance pattern SIN of phase A and a first magnetic resistance pattern COS of phase B which detect rotation of the rotation scale 55 with a phase difference of 90° with respect to each other. In other words, the sensor substrate 85 includes the first magnetic resistance pattern SIN of phase A and the first magnetic resistance pattern COS of phase B at positions at which the same wavelength obtained from the rotation scale 55 can be detected with a phase difference of 90°.

Also, the first magnetic resistance pattern SIN of phase A includes a first magnetic resistance pattern SIN+ of phase+ a and a first magnetic resistance pattern SIN− of phase −a which detect rotation of the rotation scale 55 with a phase difference of 180°. Similarly, the first magnetic resistance pattern COS of phase B includes a first magnetic resistance pattern COS+ of phase +b and a first magnetic resistance pattern COS− of phase −b which detect rotation of the rotation scale 55 with a phase difference of 180°. That is, the first magnetic resistance pattern SIN+ of phase+a and the first magnetic resistance pattern COS+ of phase +b are formed at positions at which the same wavelength obtained from the rotation scale 55 can be detected with a phase difference of 90° on the sensor substrate 85. Also, the first magnetic resistance pattern SIN− of phase −a and the first magnetic resistance pattern COS− of phase −b are formed at positions at which the same wavelength obtained from the rotation scale 55 can be detected with a phase difference of 90° on the sensor substrate 85.

In the present example, the first magnetic resistance pattern SIN (SIN+ and SIN−) of phase A and the first magnetic resistance pattern COS (COS+ and COS−) of phase B overlap in two layers on the sensor substrate 85.

More specifically, as illustrated in FIG. 7C, the first magnetic resistance pattern COS+ of phase+b is formed on the substrate surface 85a of the sensor substrate 85 and the first magnetic resistance pattern SIN+ of phase+a is stacked thereon. Also, the first magnetic resistance pattern SIN− of phase −a is formed on the substrate surface 85a of the sensor substrate 85 and the first magnetic resistance pattern COS− of phase −b is stacked thereon. Here, each of the magnetic resistance patterns COS− and SIN+ of the second layer overlapped on each of the magnetic resistance patterns SIN− and COS+ of the first layer is formed by forming an inorganic insulating layer such as SiO₂ on each magnetic resistance pattern of the first layer and stacking a magnetic material film such as a ferromagnetic material NiFe on the inorganic insulating layer. Further, a stacking relationship between the first magnetic resistance pattern SIN+ of phase +a and the first magnetic resistance pattern COS+ of phase +b may be reversed. Also, a stacking relationship between the first magnetic resistance pattern SIN− of phase −a and the first magnetic resistance pattern COS− of phase −b may be reversed.

In the present example, since the first magnetic resistance pattern SIN of phase A and the first magnetic resistance pattern COS of phase B constituting the rotational position detection magnetoresistance element 86 are stacked on the sensor substrate 85, a degree of freedom in arrangement of the first magnetic resistance pattern SIN of phase A and the first magnetic resistance pattern COS of phase B on the sensor substrate 85 increases. Accordingly, as compared to a case in which the first magnetic resistance pattern SIN (SIN+ and SIN−) of phase A and the first magnetic resistance pattern COS (COS+ and COS−) of phase B are formed on the sensor substrate 85 without being stacked, the rotational position detection magnetoresistance element 86 can be made small in the direction θ around the axis.

Here, as illustrated in FIG. 8A, the first magnetic resistance pattern SIN+ of phase +a and the first magnetic resistance pattern SIN− of phase −a constitute a bridge circuit with one ends connected to a power supply terminal (Vcc) and the other ends connected to a ground terminal (GND). Also, a terminal +a from which phase+a is output is provided at a midpoint position of the first magnetic resistance pattern SIN+ of phase +a, and a terminal −a from which phase −a is output is provided at a midpoint position of the first magnetic resistance pattern SIN− of phase −a. Therefore, when the outputs from the terminal +a and the terminal −a are input to a subtractor, it is possible to obtain a differential output of a sine wave with little distortion.

Similarly, as illustrated in FIG. 8B, the magnetic resistance pattern COS+ of phase+b and the magnetic resistance pattern COS− of phase −b constitute a bridge circuit with one ends connected to a power supply terminal (Vcc) and the other ends connected to a ground terminal (GND). A terminal +b from which phase +b is output is provided at a midpoint position of the magnetic resistance pattern COS+ of phase +b, and a terminal −b from which phase −b is output is provided at a midpoint position of the magnetic resistance pattern COS− of phase −b. Therefore, when the output from the terminal +b and the terminal −b are input to a subtractor, it is possible to obtain a differential output of a sine wave with little distortion.

Next, the origin position detection magnetoresistance element 87 has a magnetism sensing direction facing in the direction θ around the axis. As illustrated in FIG. 7A, the origin position detection magnetoresistance element 87 is provided at a position at which a magnetic field of the origin position detection magnetized region 84 can be detected when the rotation scale 55 rotates. The origin position detection magnetoresistance element 87 detects a strong and weak magnetic field generated by the origin position detection magnetized region 84.

As illustrated in FIG. 6, the linear motion scale 76 includes the linear motion position detection magnetization pattern 79 on the circumferential wall surface 76a facing outward in the radial direction. The linear motion position detection magnetization pattern 79 has a grid shape in which S-poles and N-poles are alternately arranged in the vertical direction X and the S-poles and the N-poles are alternately magnetized in the direction θ around the axis.

The linear motion position detection magnetic sensor 77 includes a sensor substrate 90 facing the linear motion scale 76 from the radial direction in a posture parallel to the axis L. Also, the linear motion position detection magnetic sensor 77 includes a linear motion position detection magnetoresistance element (first magnetic detection element) 91 formed on a substrate surface 90a facing the linear motion scale 76 on the sensor substrate 90. The sensor substrate 90 is formed of glass or silicon. The linear motion position detection magnetoresistance element 91 is formed by stacking a magnetic material film such as a ferromagnetic material NiFe on the substrate surface 90a by a semiconductor process.

The linear motion position detection magnetoresistance element 91 has a magnetism sensing direction facing in the vertical direction X. Therefore, with the linear motion position detection magnetization pattern 79 of the linear motion scale 76 in which a plurality of rows of axial direction magnetic tracks 93 each having S-poles and N-poles alternately arranged and extending in the vertical direction are provided in the direction θ around the axis, the linear motion position detection magnetoresistance element 91 detects a change in magnetic field when the linear motion scale 76 is moved.

Here, the linear motion position detection magnetoresistance element 91 detects the rotating magnetic field generated at each boundary portion between two adjacent axial direction magnetic tracks 93 (portions in which N-poles and S-poles are adjacent to each other) in the direction θ around the axis in the plurality of the axial direction magnetic tracks 93. Also, the linear motion position detection magnetoresistance element 91 detects the rotating magnetic field using a saturation sensitivity region of the magnetoresistance element. That is, the linear motion position detection magnetoresistance element 91 causes a current to flow in the magnetic resistance pattern to be described below and applies a magnetic field strength at which a resistance value is saturated thereto, and thereby detects the rotating magnetic field whose direction in an in-plane direction changes at the boundary portion. Here, when the rotating magnetic field generated by the linear motion position detection magnetization pattern 79 is detected by the linear motion position detection magnetoresistance element 91, since a sine wave component can be obtained from the linear motion position detection magnetoresistance element 91 even when the linear motion scale 76 and the linear motion position detection magnetoresistance element 91 are disposed in close proximity to each other, the linear motion position detector 20 can be configured to be compact in the radial direction.

As illustrated in FIG. 9(b), the linear motion position detection magnetoresistance element 91 includes a first magnetic resistance pattern SIN of phase A and a first magnetic resistance pattern COS of phase B which detect linear motion of the linear motion scale 76 with a phase difference of 90° with respect to each other. In other words, the sensor substrate 90 includes the first magnetic resistance pattern SIN of phase A and the first magnetic resistance pattern COS of phase B at positions at which the same wavelength obtained from the linear motion scale 76 can be detected with a phase difference of 90°.

Also, the first magnetic resistance pattern SIN of phase A includes a first magnetic resistance pattern SIN+ of phase +a and a first magnetic resistance pattern SIN− of phase −a which detect linear motion of the linear motion scale 76 with a phase difference of 180°. Similarly, the first magnetic resistance pattern COS of phase B includes a first magnetic resistance pattern COS+ of phase +b and a first magnetic resistance pattern COS− of phase −b which detect linear motion of the linear motion scale 76 with a phase difference of 180°. That is, the first magnetic resistance pattern SIN+ of phase +a and the first magnetic resistance pattern COS+ of phase +b are formed at positions at which the same wavelength obtained from the linear motion scale 76 can be detected with a phase difference of 90° on the sensor substrate 90. Also, the first magnetic resistance pattern SIN− of phase −a and the first magnetic resistance pattern COS− of phase −b are formed at positions at which the same wavelength obtained from the linear motion scale 76 can be detected with a phase difference of 90° on the sensor substrate 90.

In the present example, the first magnetic resistance pattern SIN (SIN+ and SIN−) of phase A and the first magnetic resistance pattern COS (COS+ and COS−) of phase B overlap in two layers on the sensor substrate 90.

More specifically, as illustrated in FIG. 9(c), the first magnetic resistance pattern COS+ of phase+b is formed on the substrate surface 90a of the sensor substrate 90 and the first magnetic resistance pattern SIN+ of phase+a is stacked thereon. Also, the first magnetic resistance pattern SIN− of phase −a is formed on the substrate surface 90a of the sensor substrate 90 and the first magnetic resistance pattern COS− of phase −b is stacked thereon. Here, each of the magnetic resistance patterns COS− and SIN+ of the second layer overlapped on each of the magnetic resistance patterns SIN− and COS+ of the first layer is formed by forming an inorganic insulating layer such as SiO₂ on each magnetic resistance pattern of the first layer and stacking a magnetic material film such as a ferromagnetic material NiFe on the inorganic insulating layer. Further, a stacking relationship of the first magnetic resistance pattern SIN+ of phase+a and the first magnetic resistance pattern COS+ of phase+b may be reversed. Also, a stacking relationship between the first magnetic resistance pattern SIN− of phase −a and the first magnetic resistance pattern COS− of phase −b may be reversed.

In the present example, by stacking the first magnetic resistance pattern SIN of phase A and the first magnetic resistance pattern COS of phase B constituting the linear motion position detection magnetoresistance element 91 on the sensor substrate 90, a width W1 of the linear motion position detection magnetoresistance element 91 in a direction corresponding to the direction θ around the axis of the linear motion scale 76 is made smaller than a height H1 of the linear motion position detection magnetoresistance element 91 (see an upper stage of FIG. 9(b)) in a direction corresponding to the vertical direction X of the linear motion scale 76. Further, in the present example, a center in a width direction of the linear motion position detection magnetoresistance element 91 is disposed at a position facing an apex of a curvature of the linear motion position detection magnetization pattern 79 provided on a circumferential surface of the cylindrical linear motion scale 76.

Here, the linear motion position detection magnetization pattern 79 from which the linear motion position detection magnetoresistance element 91 detects a change in magnetic field is provided on the circumferential wall surface 76a of the cylindrical linear motion scale 76. Therefore, when the sensor substrate 90 is made to face the circumferential wall surface 76a of the linear motion scale 76 in a posture parallel to the axis L, a gap G between the linear motion position detection magnetoresistance element 91 and the sensor substrate 90 varies in the direction θ around the axis (see FIG. 9A). Accordingly, when the width W1 of the linear motion position detection magnetoresistance element 91 in a direction corresponding to the direction θ around the axis of the linear motion scale 76 is made small, an influence of a magnetic strength due to a variation in the gap according to a curvature between the linear motion scale 76 and the sensor substrate 90 can be prevented with respect to an output from the linear motion position detection magnetoresistance element 91.

Here, the linear motion position detection magnetoresistance element 91 has the same circuit configuration as the rotational position detection magnetoresistance element 86. Therefore, it is easy to obtain a sine wave component with little distortion from the linear motion position detection magnetoresistance element 91. Further, since the circuit configuration of the linear motion position detection magnetoresistance element 91 is the same as that illustrated in FIGS. 8A and 8B, detailed description thereof will be omitted.

When the output shaft 2 is rotated, power is supplied to the rotation drive coils 45 of the rotation drive unit 21 to rotate the rotor 41. When the rotor 41 is rotated, the rotation is transmitted to the output shaft 2 via the ball spline bearing 36. Therefore, the output shaft 2 rotates integrally with the rotor 41. When the output shaft rotates, the rotation scale 55 rotates integrally with the output shaft 2. Therefore, a rotational position of the output shaft 2 can be acquired based on a detection signal from the rotational position detection magnetoresistance element 86 of the rotational position detection magnetic sensor 56. Further, it is also possible to acquire whether or not the output shaft 2 is at an origin position in the direction θ around the axis based on a detection signal from the origin position detection magnetoresistance element 87 of the rotational position detection magnetic sensor 56.

On the other hand, when the output shaft 2 is moved in the vertical direction X, power is supplied to the linear motion drive coils 75 of the linear motion drive unit 22. Then, the output shaft 2 that has moved in the vertical direction X is maintained at the linearly moved position after the movement by maintaining the state of supplying power to the linear motion drive coils 75. Here, when the output shaft moves in the vertical direction X, the linear motion scale moves integrally with the output shaft 2 in the vertical direction X. Therefore, a linear motion position of the output shaft 2 can be acquired based on a detection signal from the linear motion position detection magnetoresistance element 91 of the linear motion position detection magnetic sensor 77.

In the linear motion and rotation drive device 1 described above, the output shaft 2 may be inclined from a reference axis of the output shaft 2 due to tolerances of components supporting the output shaft 2 or the like.

Here, when the output shaft 2 is inclined and thereby the rotation scale 55 coaxial with the output shaft 2 is inclined, in a case in which a configuration of a rotational position detector is such that a rotation scale includes a rotational position detection magnetization pattern on a circumferential wall surface facing in a radial direction and a rotational position detection magnetoresistance element faces the rotation scale from the radial direction, there is a problem in that detection accuracy of a rotational position by the rotational position detector is likely to be deteriorated.

That is, since the circumferential wall surface of the rotation scale is curved in a circular arc shape, in a configuration in which the rotational position detection magnetoresistance element faces the rotation scale from the radial direction, a gap between the rotation scale and the rotational position detection magnetoresistance element varies around the axis based on the curvature of the circumferential wall surface of the rotation scale. Therefore, even when the output shaft 2 is not inclined and the rotation scale also is not inclined, the rotational position detection magnetoresistance element causes detection of the magnetic strength due to a variation in the gap, and thus it is not easy to accurately detect a change in the magnetic field generated by the rotation scale. Here, in addition, when the rotation scale is inclined, since an amount of variation in the gap between the rotation scale and the rotational position detection magnetoresistance element varies, the magnetic strength also fluctuates. Therefore, it is more difficult to accurately detect the change in the magnetic field generated by the rotation scale with the rotational position detection magnetoresistance element. Therefore, the detection accuracy of the rotational position by the rotational position detector is more likely to be deteriorated.

Regarding such a problem, in the rotational position detector 19 of the present embodiment, the rotation scale 55 includes the rotational position detection magnetization pattern 57 on the upper surface 55a, and the rotational position detection magnetoresistance element 86 faces the rotational position detection magnetization pattern 57 (rotation scale 55) from the upper side X2. Therefore, an amount of variation in which the gap between the rotating rotation scale 55 and the rotational position detection magnetoresistance element 86 that are rotating when the rotation scale 55 is inclined due to an inclination of the output shaft 2 varies is prevented as compared with a case in which a rotation scale includes a rotational position detection magnetization pattern on a circumferential wall surface and a rotational position detection magnetoresistance element faces the rotation scale from a radial direction. Further, in the present example, since the rotational position detection magnetoresistance element 86 faces the rotational position detection magnetization pattern 57 (rotation scale 55) from the upper side X2, the rotational position detection magnetoresistance element 86 can be disposed at a position close to the axis L of the output shaft 2 as compared with the case in which the rotational position detection magnetoresistance element is made to face the rotation scale from the outer side in the radial direction. Here, if the rotational position detection magnetoresistance element 86 is disposed at a position close to the axis L, when the rotation scale 55 is inclined, the amount of variation in which the gap between the rotating rotation scale 55 and the rotational position detection magnetoresistance element 86 varies can be prevented. Therefore, even when the rotation scale 55 is inclined, a fluctuation in the magnetic strength due to the variation in the gap between the rotating rotation scale 55 and the rotational position detection magnetoresistance element 86 can be prevented. Therefore, even when the rotation scale 55 coaxial with the output shaft 2 is inclined due to an inclination of the output shaft 2, it is possible to prevent occurrence of a phase shift in a detection signal from the rotational position detection magnetoresistance element 86, and to prevent deterioration of detection accuracy in detecting the rotational position of the output shaft 2.

Further, in the present example, since the first magnetic resistance pattern SIN of phase A and the first magnetic resistance pattern COS of phase B constituting the rotational position detection magnetoresistance element 86 are stacked on the sensor substrate 85, a degree of freedom in arrangement of the first magnetic resistance pattern SIN of phase A and the first magnetic resistance pattern COS of phase B on the sensor substrate 85 increases. Thereby, as compared with a case in which the first magnetic resistance pattern SIN of phase A and the first magnetic resistance pattern COS of phase B constituting the rotational position detection magnetoresistance element 86 are not stacked on the sensor substrate 85, it is easy to shorten a formation region of the rotational position detection magnetoresistance element 86 in the direction θ around the axis. Here, when the formation region of the rotational position detection magnetoresistance element 86 in the direction θ around the axis is shortened, since the amount of variation in the gap between the rotating rotation scale 55 and the rotational position detection magnetoresistance element 86 can be prevented even when the rotation scale 55 is inclined, a fluctuation in the magnetic strength due to the variation in the gap can be prevented. Therefore, it is possible to prevent deterioration of detection accuracy in detecting the rotational position of the output shaft 2 even when the rotation scale 55 is inclined due to the inclination of the output shaft 2.

Further, in the present example, by stacking the first magnetic resistance pattern SIN of phase A and the first magnetic resistance pattern COS of phase B constituting the linear motion position detection magnetoresistance element 91 on the sensor substrate 90, the width W1 of the linear motion position detection magnetoresistance element 91 in a direction corresponding to the direction θ around the axis of the linear motion scale 76 is made smaller than the height H1 of the linear motion position detection magnetoresistance element 91 in a direction corresponding to the vertical direction X of the linear motion scale 76. Thereby, even when the linear motion scale 76 is inclined due to the inclination of the output shaft 2, since the amount of variation in the gap G between the rotating linear motion scale 76 and the linear motion position detection magnetoresistance element can be prevented, a fluctuation in the magnetic strength due to the variation in the gap G can be prevented. Therefore, it is possible to prevent deterioration of detection accuracy in detecting the linear motion position of the output shaft 2 even when the linear motion scale 76 is inclined due to the inclination of the output shaft 2.

Further, in the present example, the origin position detection magnetized region 84 is provided in the rotation scale 55, and the rotational position detector 19 includes the origin position detection magnetoresistance element 87. Thus, an origin position of the output shaft 2 (rotation scale 55) in the direction θ around the axis can be detected.

Further, all of the first magnetic resistance pattern SIN+ of phase +a, the first magnetic resistance pattern SIN− of phase −a, the first magnetic resistance pattern COS+ of phase +b, and the first magnetic resistance pattern COS− of phase −b of the rotational position detection magnetoresistance element 86 may be stacked on the sensor substrate 85. In this way, since a formation region of the rotational position detection magnetoresistance element 86 on the sensor substrate 85 can be made more shorter in the direction θ around the axis, when the rotation scale 55 is inclined, an amount of variation in a gap between the rotating rotation scale 55 and the rotational position detection magnetoresistance element 86 can be further prevented. Therefore, even when the rotation scale 55 coaxial with the output shaft 2 is inclined due to an inclination of the output shaft 2, deterioration of detection accuracy in detecting a rotational position of the output shaft 2 can be further prevented.

Further, all of a second magnetic resistance pattern SIN+ of phase +a, a second magnetic resistance pattern SIN− of phase −a, a second magnetic resistance pattern COS+ of phase +b, and a second magnetic resistance pattern COS− of phase −b of the linear motion position detection magnetoresistance element 91 may be stacked on the sensor substrate 90.

Also, in the above-described example, although the rotation scale 55 includes the origin position detection magnetized region 84, the origin position detection magnetized region 84 may be omitted. Here, when the origin position detection magnetized region 84 is omitted, the origin position detection magnetoresistance element 87 on the sensor substrate 85 can be omitted.

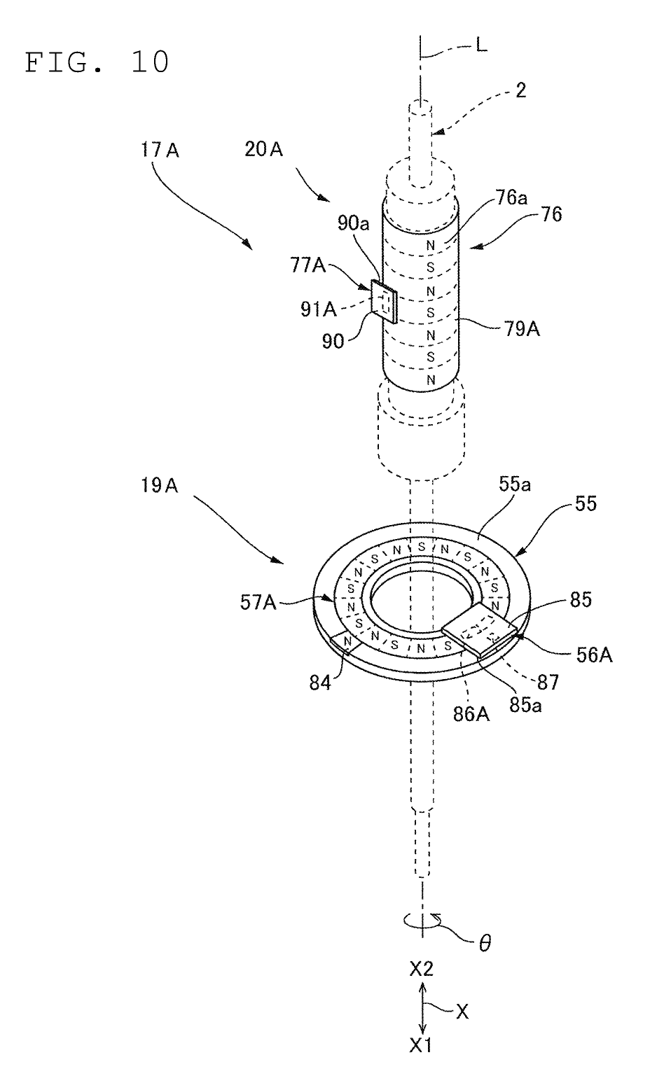

FIG. 10 is an explanatory view of a linear motion and rotation detector 17A of the modified example which can be mounted on the linear motion and rotation drive device 1 in place of the linear motion and rotation detector 17 described above. Further, since the linear motion and rotation detector 17A of the modified example has a configuration corresponding to the linear motion and rotation detector 17 described above, the corresponding portions are denoted by the same reference signs.

In the linear motion and rotation detector 17A of the present example, a rotation scale 55 constituting a rotational position detector 19A includes a rotational position detection magnetization pattern 57A having S-pole and N-pole alternately arranged in the direction θ around an axis on an upper surface 55a. That is, the rotation scale 55 includes a first magnetic track 81 as the rotational position detection magnetization pattern 57A. On the other hand, a rotational position detection magnetic sensor 56A constituting the rotational position detecting unit 19A includes a rotational position detection magnetoresistance element 86A which detects a strong and weak magnetic field of the rotational position detection magnetization pattern 57A on the sensor substrate 85. The rotational position detection magnetoresistance element 86A is provided on the sensor substrate at a position facing the rotational position detection magnetization pattern 57A. Also in this way, it is possible to obtain a sine wave component indicating a rotational position based on an output from the rotational position detection magnetoresistance element 86A.

Further, in the linear motion and rotation detector 17A of the present embodiment, a linear motion scale 76 constituting a linear motion position detector 20A includes a linear motion position detection magnetization pattern 79A having S-pole and N-pole alternately arranged in a vertical direction X on a circumferential wall surface 76a thereof. S-poles and N-poles arranged in the vertical direction X are annularly magnetized on the circumferential wall surface 76a of the linear motion scale 76. On the other hand, a linear motion position detection magnetic sensor 77A constituting the linear motion position detector 20A includes a linear motion position detection magnetoresistance element 91A which detects a strong and weak magnetic field of the linear motion position detection magnetization pattern 79A on a sensor substrate 90. The linear motion position detection magnetoresistance element 91A is provided on the sensor substrate at a position facing the linear motion position detection magnetization pattern 79A. Also in this way, it is possible to obtain a sine wave component indicating the linear motion position based on an output from the linear motion position detection magnetoresistance element 91A.

Here, the rotational position detector 19 of the linear motion and rotation detector 17 and the linear motion position detection unit 20A of the linear motion and rotation detector 17A can be employed as a linear motion and rotation detector. Also, the rotational position detector 19A of the linear motion and rotation detector 17A and the linear motion position detector 20 of the linear motion and rotation detector 17 can be employed as a linear motion and rotation detector.

Further, in each of the rotational position detector 19 and the linear motion position detector 20, a Hall element can be used in place of the magnetoresistance element (the rotational position detection magnetoresistance element 86, the origin position detection magnetoresistance element 87, and the linear motion position detection magnetoresistance element 91).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A linear motion and rotation detector that detects displacement of a moving body that linearly moves in an axial direction and rotates around an axis, the linear motion and rotation detector comprising:
a linear motion position detector including:
a linear motion scale including a circumferential wall surface surrounding the axis and facing in a radial direction and including a linear motion position detection magnetization pattern in which an N-pole and an S-pole are magnetized on the circumferential wall surface; and
a first magnetic detection element that faces the linear motion position detection magnetization pattern from the radial direction and detects a change in magnetic field; and
a rotational position detector including:
a rotation scale including a flat surface that faces in the axial direction and includes a rotational position detection magnetization pattern in which an N-pole and an S-pole are magnetized on the flat surface; and
a second magnetic detection element that faces the rotational position detection magnetization pattern from the axial direction and detects a change in magnetic field; wherein
the linear motion scale moves in the axial direction together with the moving body; and
the rotation scale rotates together with the moving body coaxially with the moving body at a predetermined position in the axial direction.

2. The linear motion and rotation detector according to claim 1, wherein
the rotational position detection magnetization pattern includes a grid shape in which S-poles and N-poles are alternately arranged around the axis and the S-poles and the N-poles are alternately magnetized in the radial direction; and
the second magnetic detection element detects a rotating magnetic field generated at a boundary portion between the S-poles and the N-poles of the rotational position detection magnetization pattern.

3. The linear motion and rotation detector according to claim 1, wherein
the rotational position detection magnetization pattern includes S-poles and N-poles alternately arranged around the axis; and
the second magnetic detection element detects strong and weak magnetic fields of the rotational position detection magnetization pattern.

4. The linear motion and rotation detector according to claim 1, wherein
the rotation scale includes a magnetized region in which an S-pole or an N-pole is magnetized at a region different from the rotational position detection magnetization pattern of the flat surface in the radial direction; and
the rotational position detector includes a third magnetic detection element that faces the flat surface from the axial direction and is able to detect a magnetic field of the magnetized region.

5. The linear motion and rotation detector according to claim 2, wherein
the linear motion position detection magnetization pattern includes a grid shape in which the S-poles and the N-poles are alternately arranged in the axial direction, and the S-poles and the N-poles are alternately magnetized around the axis; and
the first magnetic detection element detects a rotating magnetic field generated at a boundary portion between the S-poles and the N-poles of the linear motion position detection magnetization pattern.

6. The linear motion and rotation detector according to claim 2, wherein
the linear motion position detection magnetization pattern is an arrangement in which the S-poles and the N-poles are alternately arranged in the axial direction; and
the first magnetic detection element detects strong and weak magnetic fields of the linear motion position detection magnetization pattern.

7. A linear motion and rotation detector unit comprising:
the linear motion and rotation detector according to claim 1; and
a ball spline bearing fixed to a moving body; wherein
the ball spline bearing supports the moving body to be movable in an axial direction and rotates together with the moving body; and
a rotation scale is attached to the moving body via the ball spline bearing.

8. A linear motion and rotation drive device comprising:
an output shaft;
a linear motion drive unit that moves the output shaft in an axial direction;
a rotation drive unit including a rotor rotating around an axis;
a ball spline bearing coaxially fixed to the output shaft, supporting the output shaft to be movable in the axial direction, and integrally rotating with the output shaft; and
a linear motion and rotation detector which detects displacement of the output shaft; wherein
the rotor is fixed to the ball spline bearing;
the linear motion and rotation detector includes:
a linear motion position detector including:
a linear motion scale including a circumferential wall surface surrounding the axis and facing in a radial direction and including a linear motion position detection magnetization pattern in which an N-pole and an S-pole are magnetized on the circumferential wall surface; and
a first magnetic detection element that faces the linear motion position detection magnetization pattern from the radial direction and detects a change in magnetic field; and
a rotational position detector including:
a rotation scale including a flat surface facing in the axial direction and a rotational position detection magnetization pattern in which an N-pole and an S-pole are magnetized on the flat surface; and
a second magnetic detection element that faces the rotational position detection magnetization pattern from the axial direction and detects a change in magnetic field;
the linear motion scale is fixed to the output shaft and moves in the axial direction together with the output shaft; and
the rotation scale is fixed to the rotor and rotates together with the output shaft coaxially with the output shaft at a predetermined position in the axial direction.
